(19) United States
(12) Patent Application Publication
(10) Pub. No.: US 2012/0175396 A1
(43) Pub. Date: Jul. 12, 2012

(54) STRUCTURAL SUPPORT DEVICE FOR LAPTOP AND PORTABLE ELECTRONIC DEVICE CARRYING CASES

(76) Inventor: Gustavo Leon Patino, Norcross, GA (US)

(21) Appl. No.: 12/985,804

(22) Filed: Jan. 6, 2011

(51) Int. Cl. A45F 3/04; F16M 13/00; A45F 3/02

(52) U.S. Cl. 224/627; 224/600; 248/682; 248/690; 248/687

(57) ABSTRACT

A support structure for portable electronic devices is disclosed. The support structure includes two members that are pivotally connected. The first member includes an orthogonal section to prevent contact between the surface of first member and the surface of second member when the support structure is in the closed position. The second member is provided with a restraining flange and at least one restraint strap for securing the portable electronic device to the support structure.

### TECHNICAL FIELD

This invention relates to the field of carrying cases for portable computing devices specifically designed to allow the person to make use of the laptop or the portable electronic device as a workstation while standing, walking or seated without removing it from the case.

### BACKGROUND

The evolution of the computer market is well publicized. During recent years, sales of laptop computers have been rising as compared with “desktop” predecessors. Even more recent, the boom of notebooks and netbooks with increased efficiency and low price are expanding this segment at an accelerated rate. Adding to this, the development of new portable computing devices such as tabloids, video consoles and video games demand immediate connectivity with wireless or “on-the-go” systems.

People of all ages, social strata and gender want permanent and constant use of their computers either as a work tool in their office or as a personal tool with the emergence of “social networks”. This validates people not only need “portability” and/or the ability to take their tool from place to place, but also be able to make use of them whenever and wherever. The carrying case needs the ability to not only carry and protect, but also perform as a portable workstation. Providing users an easy, stable solid surface without removal from the case is true on-the-go computing.

There have been many patented inventions of similar concepts, but with very different designs. Some examples include Carrying Case for Mobile Office, U.S. Pat. No. 6,597,568 B2 Martin Dennis, relates to a briefcase or carrying case for a mobile office, holding a number of interconnected electronic devices. Laptop Transport and Support System for Mobile Environments, U.S. Pat. No. 6,659,319 B2 William J. Purpura, is a laptop computer transport and support system for mobile environments such as seats on a airplane, bus or train. Tablet and Notebook PC Carrier, Pub No US 2007/0051766 A1, Donald B. Spencer, provides a carrier for hands-free support of tablet and notebook computers to allow use of the device while standing upright. Laptop Computer Carrying Tray, U.S. Pat. No. 5,724,225 John Hrosdf.

Therefore, while these inventions focused on the functional design of the bag or “carrying case”, this invention is an independent “structural support” utilized in any style carrying case the market desires (case, bag, backpack). It is the unique design of the SSD that permit dual function of “carry case” and “workstation”.

### SUMMARY

In general, this invention provides a Structural Support Device (SSD) for laptop computers and portable electronic device carrying cases that becomes an integral design component so when “in-use” provides an ideal support for active mode. When positioned in a perpendicular orientation to the computer user's body, the user is permitted to operate the unit in one easy motion without having to take the unit out of the case. The user will not have to utilize any additional elements or make any complicated maneuvers. This provides the user an instant work station with a flat, horizontal or stationary surface. As an additional advantage, the SSD provides an improved internal structure to the carrying case protecting the equipment from substantial shocks, impacts and the like.

Another objective of this invention is to enable SSD for various types of carrying cases. Cases can take the shape of a bag, case or backpack. These “covers” come with different compartments allowing the user to carry other things such as batteries, cables, cell phones, pens, books, etc. These “covers” vary in design: sport, casual, business. They vary in style and materials: fabrics, fibers, leathers. They have wide padded straps attached to distribute the weight of the carrying case and its content. These padded straps vary depending on the case, bag or backpack shape.

In the bag shape, the wide padded straps are crossed in front, allowing the carrying case to be more comfortable. The wide frontal support lets the bag adhere to the body of the user. The cross strap distributes the weight across the shoulder and back, eliminating stress on the user's neck.

The backpack shape has two wide-padded straps joined by a circular ring at the top which allows users to make adjustments to their shoulders. When the backpack is “in-use” mode, the weight is distributed on both shoulders and back. This permits the user of the laptop or electronic device extended comfort for long periods of time, even if standing, walking or seated.

Internal compartments allow the user to store accessories necessary for the laptop or electronic device such as batteries, chargers, cables, etc, and additional elements like pencils, pens, CD's and more. These carrying cases are not designed for a specific size. Depending type of computer or electronic device, dimensions may vary.

Another objective of this invention is to manufacture SSD with lightweight yet strong materials consistent with durable and reliable construction.

Another objective of this invention to provide the user with TOTAL visibility to the computer screen or device viewing area without obstruction of belts or other support elements.

Another objective of this invention is to provide TOTAL accessibility to the keyboard appliance, or in the case of a tablet style, unobstructed access to the horizontal working area.

Another objective of this invention is to provide structure and support to the case. The SSD is made of rigid material and constructed as a hinge. This permits the surface support to fold and unfold. By design, this hinge creates the necessary range of motion so the internal structure can work as packaging or as a work surface for the computer or electronic device. The horizontal support surface of the SSD is free of edges or side enhancements. This space is totally open on the sides, front and back, providing easy access to all ports of the laptop or electronic device for complete connectivity to tools or peripherals. The horizontal support surface is perforated to help ventilate the laptop computer or electronic device. The vertical portion of the SSD is also perforated to reduce weight and provide access to internal compartments of the bag.

### BRIEF DESCRIPTION OF THE DRAWINGS

FIG. 1—is an isometric view showing the present invention without any cover (bag or backpack presentations).

FIG. 2—is an isometric view showing the present invention separated into its three basic components.

FIG. 3—is an isometric view of the SSD with the laptop or electronic device attached in its active mode or “use-mode”.

FIG. 4—is a section view of the SSD with the laptop or electronic device attached in its active mode or “use-mode”.

FIG. 5—is a side view of the SSD with a laptop or electronic device attached in its passive mode or “carrying mode”.

FIG. 6—is a side view of the SSD with a laptop or electronic device initiating the movement to change from a passive mode or “carrying mode” to an active mode or “use-mode”.

FIG. 7—is a side view of the SSD with a laptop or electronic device fully unfolded.

FIG. 8—is a side view of the SSD with a laptop or electronic device showing how its top part unfolds (in case there is one) and its “use-mode” position.

FIG. 9—is a close-up of the articulated part of the SSD, in passive mode or “carrying mode”.

FIG. 10—is a close-up of the articulated part of the SSD, in active mode or “use-mode”.

FIG. 11—is showing that the SSD is a unique internal structure that can fit into different shapes.

FIG. 12—is an isometric view showing the SSD with the case in a bag shape, closed.

FIG. 13—is an isometric view showing the SSD with the case in a bag shape, with the SSD fully unfolded.

FIG. 14—is an isometric view showing the SSD with the case in a bag shape, unfolding the monitor of the laptop or electronic device.

FIG. 15—is an isometric view showing the SSD with the case in a bag shape with the laptop or electronic device fully unfolded.

FIG. 16—is an isometric view showing the SSD with the case in a bag shape, open, unfolded, without the laptop or electronic device.

FIG. 17—is a section view showing the SSD in the case in a bag shape.

FIG. 18—is an isometric view of the bag without the SSD.

FIG. 19—is an isometric view of the bag showing the crossing strap.

FIG. 20—is a frontal pictorial view of the present invention, showing how the bag is positioned on the user's body.

FIG. 21—is a back pictorial view of the present invention showing the crossing back strap.

FIG. 22-FIG. 27—is a sequence of pictorial views of the present invention with the case in a bag shape, showing how to go from passive mode or “carrying mode” to active mode or “use-mode”.

FIG. 28—is an isometric view showing the SSD with the case in a backpack shape, closed.

FIG. 29—is an isometric view showing the SSD with the case in a backpack shape, with the SSD fully unfolded.

FIG. 30—is an isometric view showing the SSD with the case in a backpack shape, unfolding the monitor of the laptop or electronic device.

FIG. 31—is an isometric view showing the SSD with the case in a backpack shape with the laptop or electronic device fully unfolded.

FIG. 32—is an isometric view showing the SSD with the case in a backpack shape, open, unfolded, without the laptop or electronic device.

FIG. 33—is a section view showing the SSD in the case in a backpack shape.

FIG. 34—is an isometric view of the backpack without the SSD.

FIG. 35—is an isometric view of the backpack showing its wide padded straps which are joined to the backpack by a circular ring.

FIG. 36—is a frontal pictorial view of the present invention, showing how the backpack is positioned on the user's body.

FIG. 37—is a back pictorial view of the present invention showing the wide padded straps on the user's back.

FIG. 38-FIG. 43—is a sequence of pictorial views of the present invention with the case in a backpack shape, showing how to go from passive mode or “carrying mode” to active mode or “use-mode”.

FIG. 44-FIG. 48—is a sequence of pictorial views of the present invention showing how the user makes use of the laptop or electronic device with the carrying case (including the SSD), in a bag shape.

FIG. 49-FIG. 52—is a sequence of pictorial views of the present invention showing how the user makes use of the laptop or electronic device with the carrying case (including the SSD), in a backpack shape.

### DETAILED DESCRIPTION OF ILLUSTRATIVE EMBODIMENTS

The invention disclosed herein is, of course, susceptible to embodiment in many different forms. Shown in the drawings and described here in detail are preferred embodiments of the invention. It is to be understood, however, that the present disclosure is an exemplification of the principles of the invention and does not limit the invention to the illustrated embodiments.

The present invention does not make reference to changes, aesthetic improvements or functional improvements in a carrying case, this being in a bag shape or in a backpack shape.

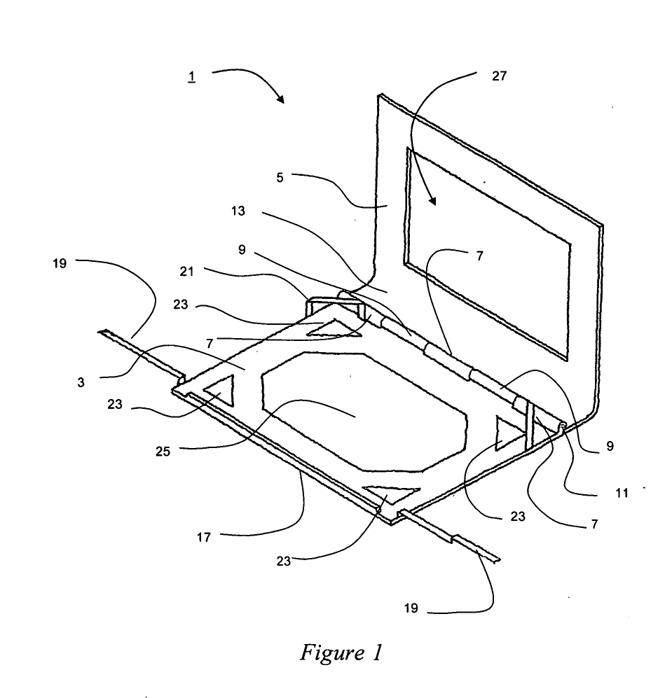

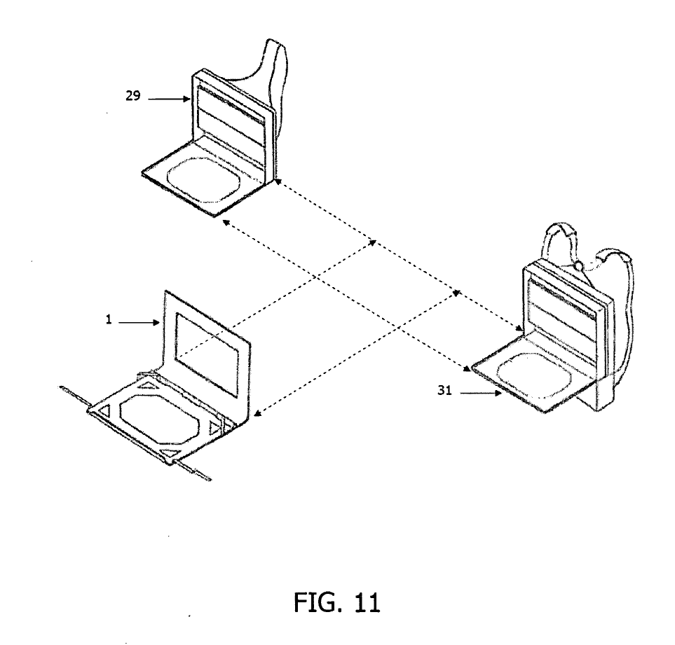

The present invention is a “device” FIG. 1-FIG. 10 that incorporates to the interior of the carrying case FIG. 11 becoming in its “structural” part, and in an internal element of protection and support.

In this present invention, the carrying case and its different shapes, bag or backpack FIG. 12-FIG. 52, are elements of housing or wrapper elements.

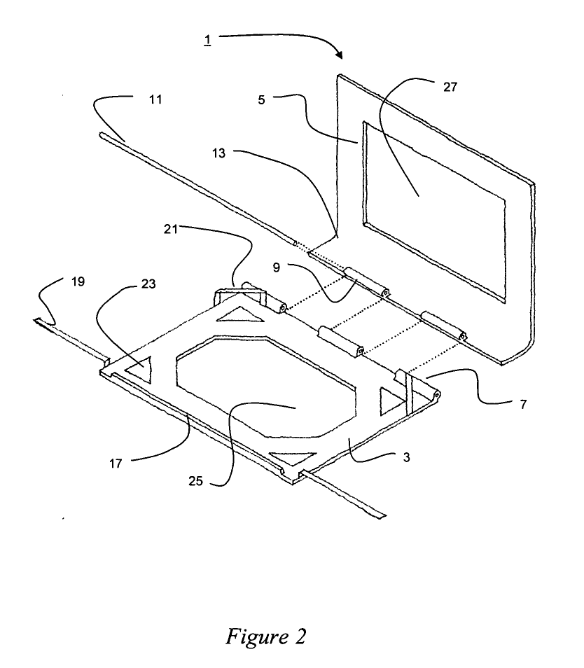

It is shown in FIGS. 1 and 2 of the drawings an isometric view of the present invention or SSD 1, in its elemental form, without any covers. The SSD 1 has two solid surfaces, substantially planar horizontal support 3 and substantially planar vertical support 5 that are articulated, and preferably made of a light weight material such as a nonmetallic “composite material”, or substantially rigid plastic.

The horizontal support 3 and the vertical support are flat and substantially rigid surfaces that are hinged together with hinge barrels 7 and 9 and pin 11. Vertical support 5 has an L shape, were the horizontal bottom part 13 is the designated space to keep and support the laptop or electronic device (not shown). The horizontal support 3 is also provided with a with a back-stop or flange 17 which functions is to prevent the laptop or electronic device from sliding or going out of the SSD 1. Horizontal support 3 may also be provided with a Velcro strap 19 on the back of the surface of the horizontal support 3 and a pair of holding members 21 disposed adjacent to the hinge barrels 7 which may consist of elastic bands. They call the members 21 and Velcro strap 19 prevent movement of the laptop or electronic device when the user changes to a different position. The horizontal support 3 may additionally be provided with “anti-slid” or friction pads 23. The friction pads 23 may be made of rubber, or other resilient material Horizontal support 3 is provided with an open space 25 to let the laptop or electronic device ventilate.

Vertical support 5, is provided with a big perforation 27 to reduce weight to the structure and also provides access to a back compartment of the case containing accessories as will be explained below.

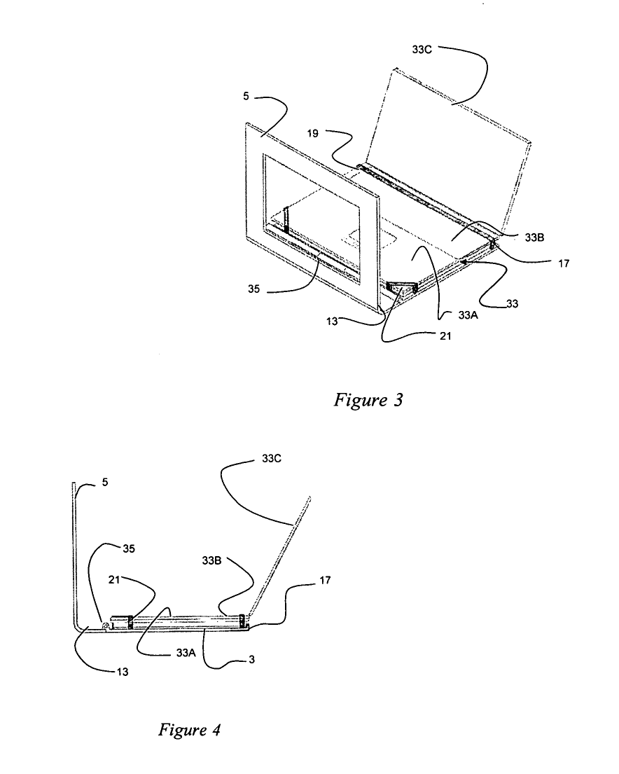

FIG. 3 shows an isometric view of the SSD 1 with a laptop or electronic device 33 attached. The elastic bands 21 hold the frontal bottom part 33A of the laptop or electronic device 33 to the SSD 1; in the back, against the back-stop 17, the Velcro straps 19 works as a “holding” element in the bottom back of the laptop or electronic device 33. In this way, the user is completely free to access the keyboard area 33A-33B, and having the monitor “unfolded” or open 33C, the visual field of this, is totally open, as shown also in FIG. 4, section view. The hinge union 35 works as a front-stop to prevent movement of the laptop or electronic device 33.

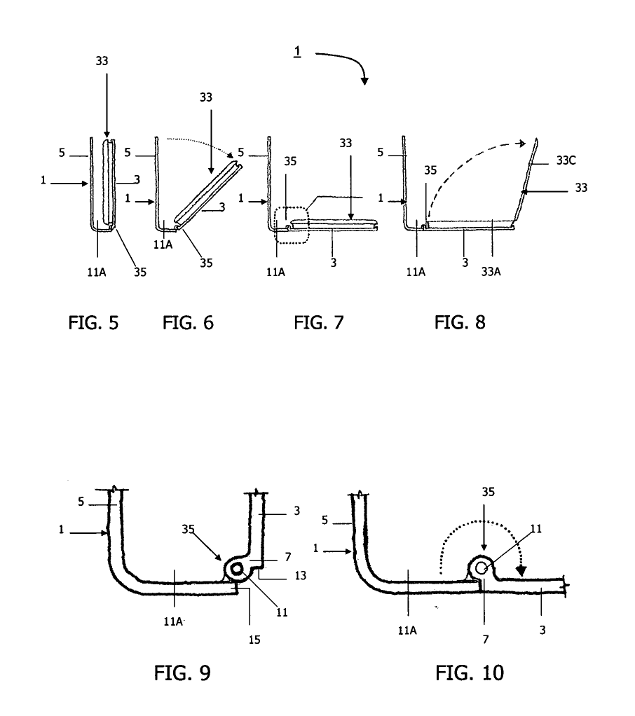

FIG. 5 through FIG. 8 are a sequence that show in four section views, the operation of the SSD 1, changing from its passive mode or “carrying mode” FIG. 5, when it is a “container” of the laptop or electronic device 33, and goes to its active mode or “use-mode” FIG. 8.

The SSD 1 articulates in the hinge union 35, making a 90 degree rotary motion on the pin loop 11. This motion is stopped by the shape of each of the surface's edges; the angular straight cut in the vertical support 15, against the angular straight cut of the horizontal support 13, FIG. 9, collide with each other, as shown in FIG. 10. When this happens, the rotary motion stops, giving the support needed to the Horizontal Support 3.

As shown in FIG. 11, the SSD 1 is a unique structural internal piece that fits in the “carrying case” either in its bag shape 29 or in its backpack shape 31.

The isometric views, FIG. 12-FIG. 16, show a sequence of the present invention, the SSD 1 “wrapped” in its bag shape 29 from the moment it is fully closed FIG. 12 to the moment when it is opened FIG. 13, unfolding or “activating” the monitor of the laptop or electronic device 33, FIG. 14-FIG. 15. Finally, it shows the SSD 1 in its bag shape 29 fully opened, without the laptop or electronic device 33 as shown in FIG. 16.

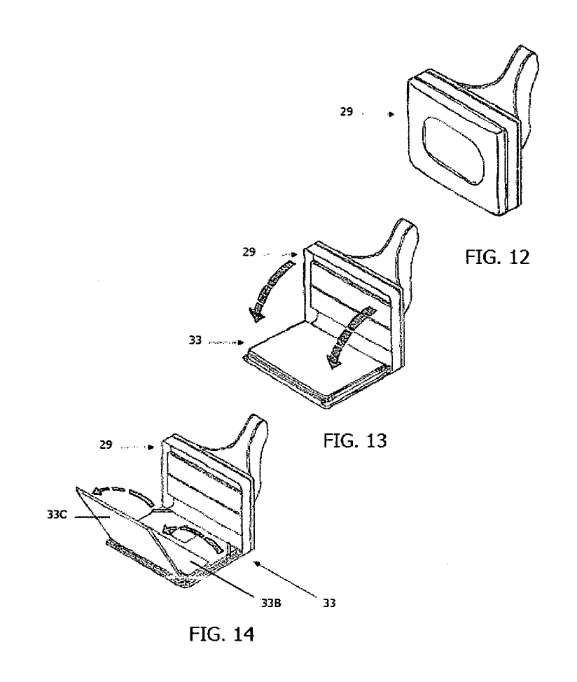

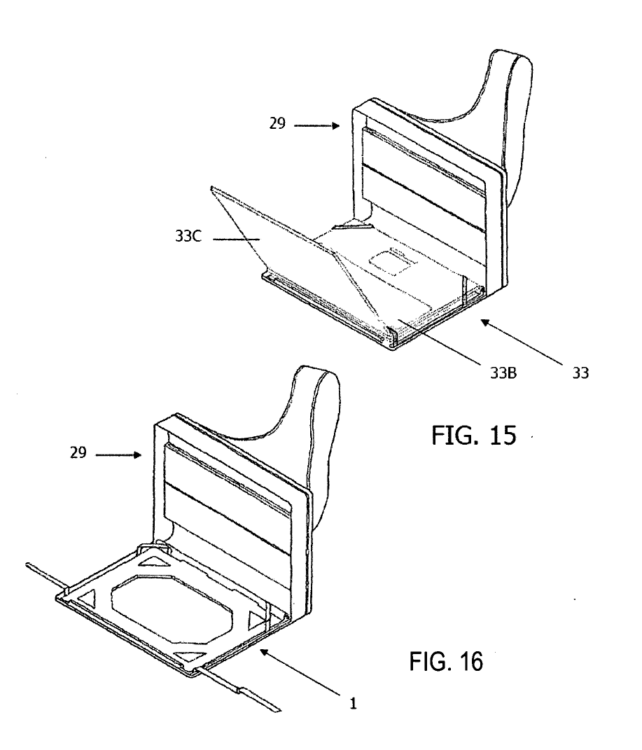

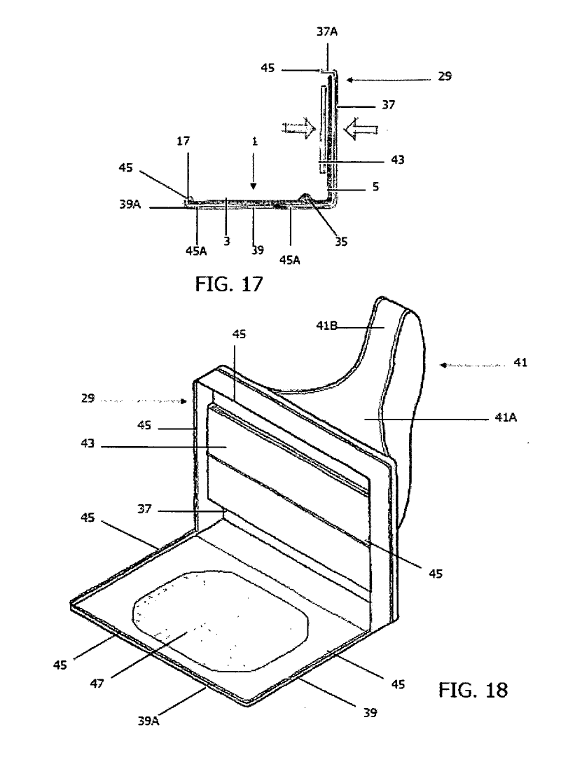

FIG. 17 is a section view showing how the carrying case in its bag shape 29 and the SSD 1 fit. The horizontal support 3 of the SSD 1 is attached to the front side or horizontal cover 39 with an elastometric adhesive 45A. An elongation or side wall 39A of the horizontal cover 39 ends at the sealing element or zipper 45, fully confining the SSD 1 to the horizontal support 3. The vertical support 5, is attached to the vertical cover 37 by simple compression, when the vertical support 5 is introduced between the internal compartments 43 and the back side or vertical cover 37. An elongation or side wall 37A of the vertical cover 37 forms the necessary room for the laptop or electronic device 33, also ending at the sealing element or zipper 45.

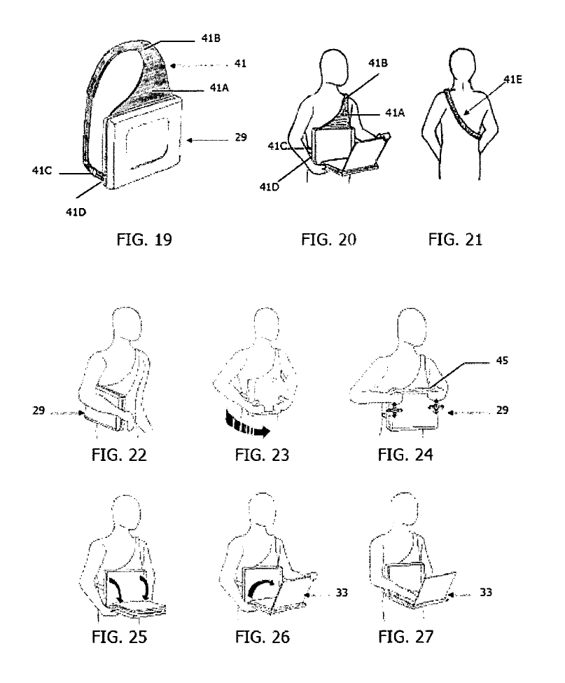

The construction of the bag 29 is a subject to many variations, modifications and changes in details. This bag 29 “cover” can vary in design, dimensions and style: sport, casual, business; or materials: fabrics, fibers, leathers. This bag consist of different elements, as shown in FIG. 18, which together achieve the main function: carry the laptop or electronic device 33 allowing the user to make use of it without taking this out of the bag. The basic elements needed in the carrying case in its bag shape 29 are: the back side or vertical cover 37, which is the main structure of support of the bag; the internal compartments 43 that have a double function: allow the user to store accessories necessary for the use of the laptop or electronic device 33, such as batteries, chargers, cables, etc, and/or other elements like pencils, pens, CDs, etc; and the other function, the main function, serve as a holding element of the vertical support 5 with the bag 29, as shown in FIG. 17. In the front side or horizontal cover 39, in addition to the zipper 45, and the side wall 39A, has a permeable area or “breathable” 47 that in its manufacturing, can be produced in different ways, either with some kind of perforation directly on the material being used to its production, or utilizing a “permeable” material that allows an air flow so that the laptop or electronic device 33 can have a direct ventilation. The crossing padded straps 41 have a wide frontal support 41A, as shown in FIG. 19, and a narrowing at shoulder height 41B; a length adjustment device 41C is close to the bottom part were the bag and the straps are attached 41D, allowing the user to adjust the strap 41 using just one hand. The wide frontal support 41A lets the bag “adhere” to the body of the user FIG. 20. The narrowing at shoulder height 41B lets the user maneuver the case easily from side to side. As shown in FIG. 21, the crossed strap in the back 41E works as a support for the bag when being in its active mode or “use-mode”, avoiding excess weight on the user's neck. The weight or the “Cantilever Effort” created by the SSD 1 unfolded with the laptop or electronic device 33 is distributed on the user's shoulder and back. FIG. 22 shows how the bag is “carried” by the user. When the user wants to make use of the computer, just needs to turn the bag 29 from the side to the front FIG. 23, and then the user manipulates the closing mechanisms or zipper 45 to open the case FIG. 24, and opens the cover of the case that will serve as a support base for the computer FIG. 25. Then the user can proceed to “open” the computer or electronic device 33, FIG. 26, without having to remove it from the bag 29. Now the user can turn ON the computer or electronic device 33 and start using it, as shown in FIG. 27.

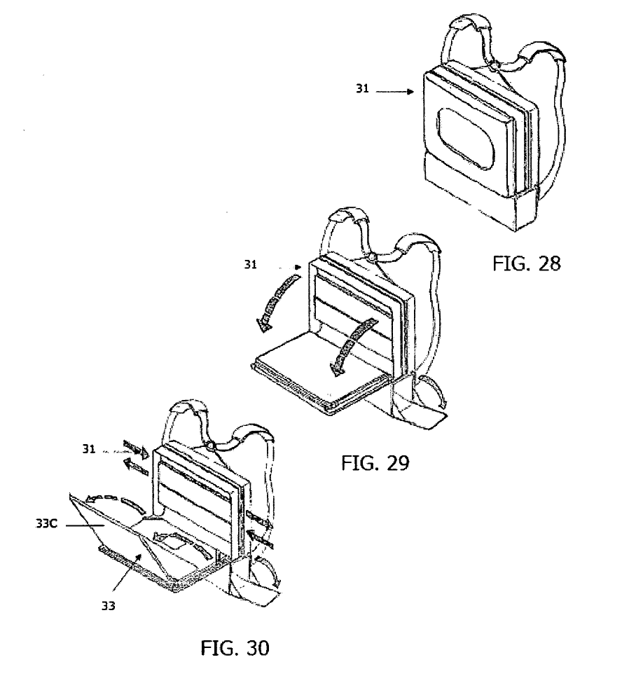

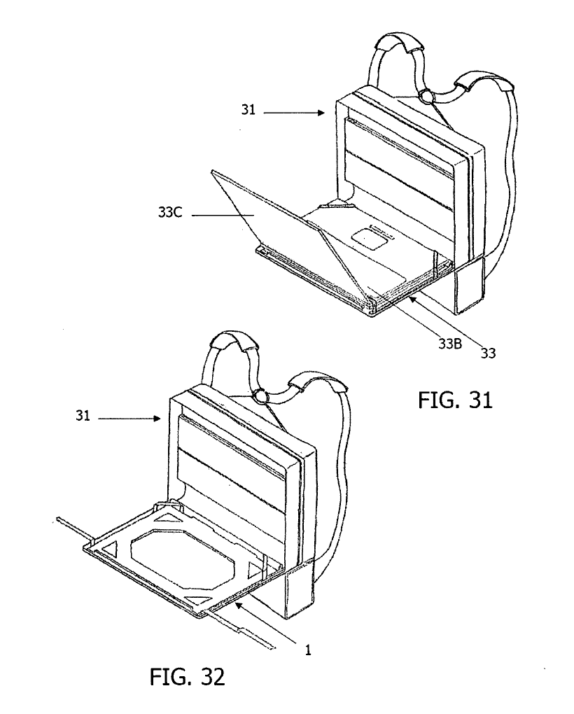

The isometric views FIG. 28-FIG. 32, show a sequence of the present invention, the SSD 1 “wrapped” in its backpack shape 31, from the moment it is fully closed FIG. 28, to the moment when it is opened FIG. 29, unfolding or “activating” the monitor of the laptop or electronic device 33, FIG. 30-FIG. 31. Finally, it shows the SSD 1 in its backpack shape 31 fully opened, without the laptop or electronic device 33 as shown in FIG. 32.

FIG. 33 is a section view that shows how the carrying case in its backpack shape 31 and the SSD 1 fit. The horizontal support 3 of the SSD 1 is attached to the front side or horizontal cover 39 with an elastometric adhesive 45A. An elongation or side wall 39A of the horizontal cover 39 ends at the sealing element or zipper 45, fully confining the SSD 1 to the horizontal support 3. The vertical support 5 is attached to the vertical cover 37 by simple compression, when the vertical support 5 is introduced between the internal compartments 43 and the back side or vertical cover 37. An elongation or side wall 37A of the vertical cover 37 forms the necessary room for the laptop or electronic device 33, also ending at the sealing element or zipper 45. In the back part, behind the back side 37, it has a back compartment 51 or an additional storage space as well as a lower compartment 53 in the bottom part.

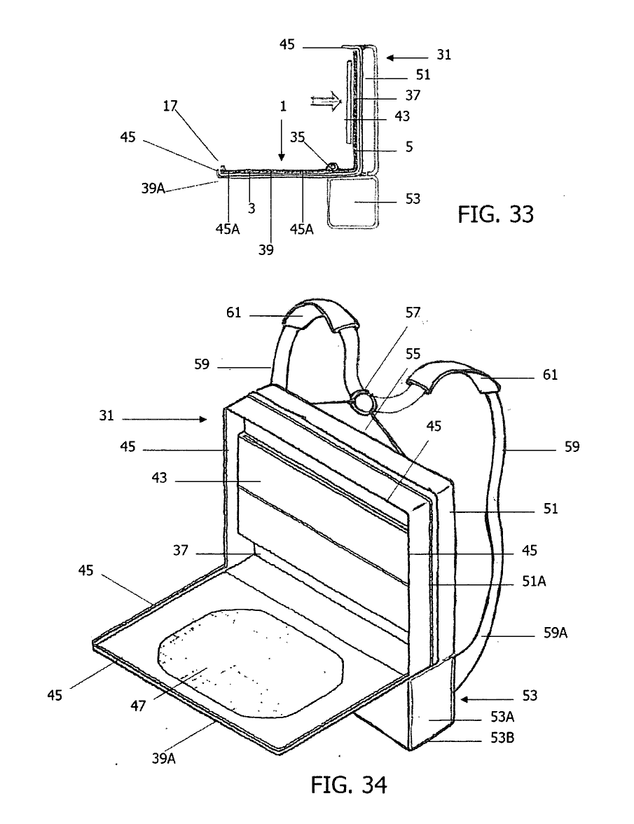

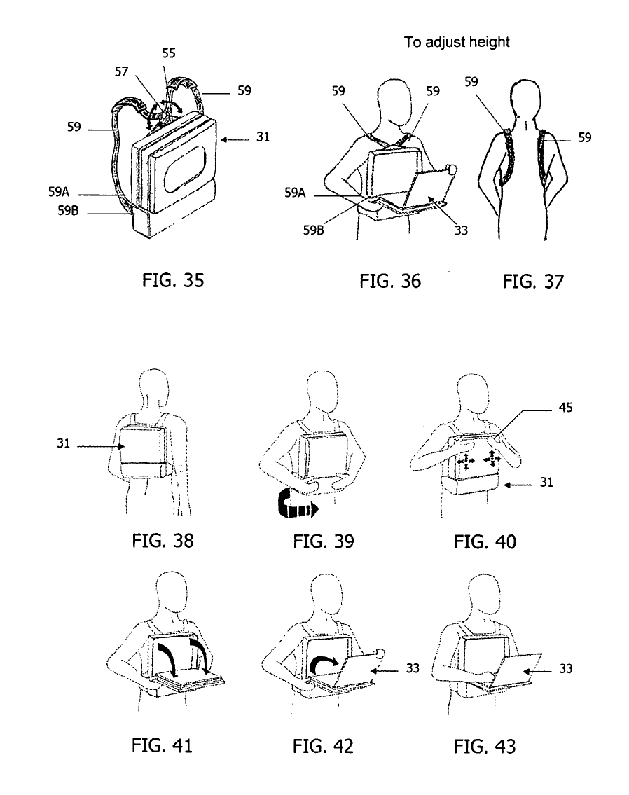

The construction of the backpack 31 is a subject to many variations, modifications and changes in details. This backpack 31 “cover” can vary in design, dimensions and style: sport, casual, business; or materials: fabrics, fibers, leathers. This backpack consist of different elements, as shown in FIG. 34, which together achieve the main function: carry the laptop or electronic device 33 allowing the user to make use of it without taking this out of the backpack. The basic elements needed in the carrying case in its backpack shape 31 are: the back side or vertical cover 37, which is the main structure of support of the backpack; the internal compartments 43 that have a double function: allow the user to store accessories necessary for the use of the laptop or electronic device 33, such as batteries, chargers, cables, etc, and/or other elements like pencils, pens, CDs, etc; and the other function, the main function, serve as a holding element of the vertical support 5 with the backpack 31, as shown in FIG. 33. In the front side or horizontal cover 39, in addition to the zipper 45, and the side wall 39A, has a permeable area or “breathable” 47 that in its manufacturing, can be produced in different ways, either with some kind of perforation directly on the material being used to its production, or utilizing a “permeable” material that allows an air flow so that the laptop or electronic device 33 can have a direct ventilation. Access to the back compartment 51 is by two lateral zippers 51A, one at each side of the backpack 31. The access to the lower compartment 53 is through an access lid 53, controlled by a zipper or snap closure 53B. Attached to the upper back side 37, FIG. 35, is a central support 55 which has one or two “O”rings 57 or articulated links, from where the adjusting straps 59 are attached. The straps have a “puffed” element 61 at shoulder height for user's comfort; a length adjustment device 41C is close to the bottom part were the bag and the straps are attached 41D, allowing the user to adjust the strap 41 using just one hand. The two wide padded straps 59 joined to the backpack 31 by a “O”ring 57 lets them adjust to the user's shoulder FIG. 36 when using it, either on the front or on the back. The purpose of using the backpack 31 on the front is to distribute the weight or the “Cantilever Effort” created by the SSD 1 unfolded with the laptop or electronic device 33, on both shoulders and back FIG. 37, allowing the user to use the laptop or electronic device 33 for long periods of time.

As shown in FIG. 38, the carrying case in the backpack shape 31, in a “carrying mode”, is carried by the user on shoulders and back. When the user wants to make use of the computer, just needs to turn the backpack 31 from the back to the front FIG. 39, and then the user manipulates the closing mechanisms or zipper 45 to open the case FIG. 40, and opens the cover of the case that will serve as a support base for the computer FIG. 41. Then the user can proceed to “open” the computer or electronic device 33, FIG. 42, without having to remove it from the backpack 31. Now the user can turn ON the computer or electronic device 33 and start using it, as shown in FIG. 43.

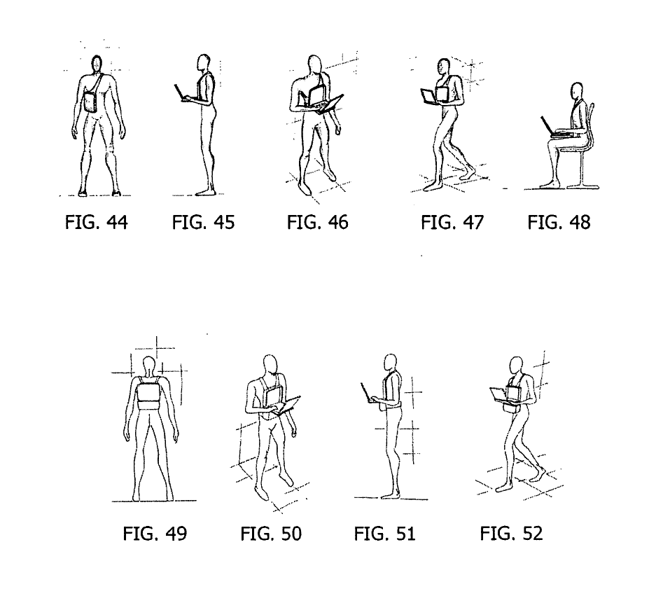

The SSD 1 in any of its shapes, either as a bag 29 or as a backpack 31, is specifically designed with two functions: the first one is to carry any laptop or electronic device 33 in a comfortable, light and safe way FIG. 44, FIG. 49; and the second, to allow the person who is carrying the laptop or computer device 33 to make use of this in an easy and simple way, without having to take this out of the case, without having to utilize any additional elements, or, to do any complicated maneuvers. This device, as a structural part of the cases, allows the use of the laptop or electronic device 33 even if the person is standing FIG. 45-FIG. 46, FIG. 50-FIG. 51, walking FIG. 47, FIG. 52 or seated FIG. 48.

What is claimed:

1. A structural support apparatus for a portable electronic device comprising:
a first member having a first portion that is substantially planar and a second portion that is substantially orthogonal to the first portion;
a second member the second member being substantially planar and having a central cutout portion to allow for ventilation of the portable electronic device;
a pivot pivotally connecting the first member to the second member;
at least one friction pad secured to the second support member disposed to frictionally engage an outer area of the portable electronic device; and
at least one restraining member attached to the second member and disposed to secure at least a portion of the portable electronic device to the second member.

2. The structural support apparatus of claim 1 wherein the first member and the second member are made of substantially rigid light-weight material.

3. The structural support apparatus of claim 1 wherein the second member has a proximate side aligned with the pivot, a distal side away from the pivot and two lateral sides, and the restraining member is at least one elastic strap disposed diagonally from one of the lateral sides to the proximate side.

4. The structural support apparatus of claim 1 wherein the second member has a proximate side aligned with the pivot, a distal side away from the pivot and two lateral sides and wherein the restraining member is a strap disposed transversely from one of the lateral sides to the other lateral side.

5. The structural support apparatus of claim 1 wherein the retraining member comprises a pair of straps and further comprising a fastener for fastening the pair of straps together.

6. The structural support apparatus of claim 1 wherein
the first member has at least one hinge barrel;
the second member has at least one hinge barrel; and
the pivot comprises a pin disposed through the hinge barrel on the first member and the hinge barrel of the second member.

7. The structural support apparatus of claim 1 wherein the second member has a proximate side aligned with the pivot, a distal side away from the pivot and two lateral sides and further comprising a restraining flange along the distal side.

8. The structural support apparatus of claim 7 wherein the portable electronic device has a predetermined width, depth and height and wherein the distance from the proximate side of the second member and the restraining flange is larger than the depth of the portable electronic device.

9. The structural support apparatus of claim 1 wherein the orthogonal dimension of the second portion of the first member is larger than the height of the portable electronic device.

10. The structural support apparatus of claim 1 wherein the friction pad comprises a rubber insert attached to the top surface of the second member.

11. A carrier for portable electronic device comprising:
a case comprising a front panel and a rear panel;
a harness attached to the rear panel;
a structural support device secured to the carrier, the structural support device comprising:
a first member having a first substantially planar portion and a second portion that is substantially orthogonal to the first portion;
a second support member pivotally attached to the first member, the second support member being substantially planar and having a central cutout portion to allow for ventilation of the portable electronic device; and
at least one restraining member attached to the second support member and disposed to secure at least a portion of the portable electronic device to the second support member.

12. The carrier of claim 11 wherein the first member is removably secured to the rear panel.

13. The carrier of claim 11 wherein the second member is removably secured to the front panel.

14. The carrier of claim 11 wherein the harness is an over the shoulder harness.

15. The carrier of claim 11 wherein the harness is a backpack harness.

16. The carrier of claim 11 wherein the structural support device further comprises at least one friction pad secured to the second support member disposed to frictionally engage an outer surface of the portable electronic device.
